(19) United States
(12) Patent Application Publication
(10) Pub. No.: US 2022/0416372 A1
(43) Pub. Date: Dec. 29, 2022

(54) ELECTRODE PLATE OF SECONDARY BATTERY AND PREPARATION METHOD THEREOF, SECONDARY BATTERY

(71) Applicant: XIAMEN HITHIUM NEW ENERGY TECHNOLOGY CO., LTD., Xiamen, Fujian (CN)

(72) Inventor: QIN ZHANG, Xiamen, Fujian (CN)

(21) Appl. No.: 17/777,989

(22) PCT Filed: Jan. 14, 2021
(86) PCT No.: PCT/CN2021/071678

§ 371 Date: May 18, 2022

(30) Foreign Application Priority Data
Nov. 19, 2019 (CN) 201911139155.2
Nov. 19, 2019 (CN) 201922010199.7

(51) Int. Cl. H01M 50/533; H01M 50/536

(52) U.S. Cl. CPC H01M 50/533; H01M 50/536

(57) ABSTRACT

Provided are an electrode plate of a secondary battery, a preparation method thereof, and a secondary battery, which belong to the field of the secondary battery technologies. The electrode plate includes a current collector and a tab assembly. The tab assembly includes a first tab including a first current collector connection region that covers and is connected to an outer surface of the first conductive layer and a second tab. The first tab includes a first current collector connection region that covers and is connected to an outer surface of the first conductive layer, and the second tab includes including a second current collector connection region that covers and is connected to an outer surface of the second conductive layer. A first recessed region is defined at a connection between the tab assembly and the current collector. In the first recessed region, the first current collector connection region of the first tab and the first conductive layer are stacked with each other and both embedded in the insulation layer, and each of the first current collector connection region and the first conductive layer has a recessed outer surface. The first conductive layer is electrically connected to the second conductive layer in the first recessed region.

### CROSS-REFERENCES TO RELATED APPLICATIONS

This application claims a priority to Chinese Patent Application No. 201911139155.2, titled “ELECTRODE PLATE OF SECONDARY BATTERY AND PREPARATION METHOD THEREOF, SECONDARY BATTERY” and claims a priority to Chinese Patent Application No. 201922010199.7, titled “ELECTRODE PLATE OF SECONDARY BATTERY, SECONDARY BATTERY”, and filed on Nov. 19, 2019, the entire disclosures of which are incorporated herein by reference.

### FIELD

The present disclosure relates to the field of secondary battery technologies, and in particular, to an electrode plate of a secondary battery, a preparation method thereof, and a secondary battery.

### BACKGROUND

In the related art, a composite current collector includes an insulation layer, a first conductive layer and a second conductive layer that are arranged on two surfaces of the insulation layer respectively. Since the first conductive layer and the second conductive layer are connected to each other by the insulation layer, and the insulation layer is non-conductive, a current on the first conductive layer cannot be directly conducted with that on the second conductive layer. Therefore, it is necessary to arrange metal foils on the first conductive layer and the second conductive layer, respectively to shunt the currents and then collect them onto a post.

In the related art, there is no effective connection between the first metal foil and the second conductive layer and between the second metal foil and the second conductive layer.

### SUMMARY

An object of the present disclosure is to provide an electrode plate of a secondary battery, a preparation method thereof, and a secondary battery, in which a connection structure is more stable, and a connection effect is good.

In order to realize at least one of the above objects of the present disclosure, the present disclosure may include the following technical solutions.

In a first aspect of embodiments of the present disclosure, there is provided an electrode plate of a secondary battery including a current collector and a tab assembly. The current collector includes an insulation layer, a first conductive layer and a second conductive layer that are arranged on two surfaces of the insulation layer, respectively. The tab assembly includes a first tab and a second tab. The first tab includes a first current collector connection region that covers and is connected to an outer surface of the first conductive layer, and the second tab includes a second current collector connection region that covers and is connected to an outer surface of the second conductive layer. A first recessed region is defined at a connection between the tab assembly and the current collector. In the first recessed region, the first current collector connection region of the first tab and the first conductive layer are stacked with each other and both embedded in the insulation layer, and each of the first current collector connection region and the first conductive layer has a recessed outer surface. The first conductive layer is electrically connected to the second conductive layer in the first recessed region.

The first current collector connection region is connected to the first conductive layer, and thus a current on the first conductive layer can be collected onto the first tab. The second current collector connection region is connected to the second conductive layer, and thus a current on the second conductive layer can be collected onto the second tab. Since in the first recessed region the first current collector connection region and the first conductive layer are embedded in the insulation layer, and the first current collector connection region and the first conductive layer has the recessed outer surface, the first conductive layer and the second conductive layer are electrically connected to each other in the first recessed region. That is, in the first recessed region, the insulation layer is pressed by the recessed first current collector connection region and the recessed first conductive layer, so that the insulation layer in the first recessed region diffuses towards a periphery thereof to be penetrated, which results in an electrical connection between the first conductive layer and the second conductive layer in the first recessed region. The connection between the first current collector connection region and the first conductive layer as well as the connection between the second conductive layer and the second current collector connection region in the first recessed region are firmer, and a certain overcurrent effect can be achieved.

In a possible implementation, the first current collector connection region, the first conductive layer, the second conductive layer, and the second current collector connection region are welded in the first recessed region.

The connection in the first recessed region is implemented by welding, which can provide firmer connection. Further, the insulation layer is pressed at the weld joint, which can ensure an integrity of the current collector to a certain extent while ensuring a connection strength, thereby ensuring a tensile strength of the tab assembly. In addition, since the first conductive layer and the second conductive layer are welded to each other, it is possible to ensure a peel strength of a part of each of the first conductive layer and the second conductive layer from the insulation layer and a peel strength of the first tab and the second tab from the current collector.

In a possible implementation, in the first recessed region, the second current collector connection region and the second conductive layer are stacked with each other and both embedded in the insulation layer, and each of the second current collector connection region and the second conductive layer has a recessed outer surface.

In the first recessed region, each of the first current collector connection region and the first conductive layer has the recessed outer surface, and each of the second current collector connection region and the second conductive layer also has a recessed outer surface opposite to the recessed outer surface of each of the first current collector connection region and the first conductive layer to form the first recessed region. During the welding, a welding seat has welding teeth arranged thereon, and a welding head also has welding teeth arranged thereon. The welding teeth on the welding seat need to correspond to the welding teeth on the welding head one by one, which results in high welding strength.

In a possible implementation, the second current collector connection region has a flat surface facing away from the second conductive layer in the first recessed region.

In the first recessed region, each of the first current collector connection region and the first conductive layer has a recessed outer surface, and the second current collector connection region is flat. During the welding, there are no welding teeth arranged on the welding seat, and welding teeth are disposed on the welding head, thus there is no need for the correspondence among the welding teeth, precision requirements of a welding machine can be reduced, and there will be no relative friction between the welding teeth. During the welding, a great amount of metal powder may be avoided, and an amount of metal powder falling on a surface of the electrode plate during the welding can be reduced, thereby avoiding a current collection from being affected.

In a possible implementation, in the first recessed region, the second conductive layer is flat. Alternatively, in the first recessed region, the second conductive layer is embedded in the second current collector connection region, and the second conductive layer has a recessed inner surface recessed towards the outer surface of the second current collector connection region.

Each of the second conductive layer and the first conductive layer are embedded in the second current collector connection region, and the welding is performed by a higher pressure and a higher strength without penetration-welding the second current collector. Thus, the welding strength is high.

In a possible implementation, the first tab further includes a first tab connection region connected to the first current collector connection region, and the second tab further includes a second tab connection region connected to the second current collector connection region. A second recessed region is defined at a connection between the first tab connection region and the second tab connection region. In the second recessed region, the first tab connection region is electrically connected to the second tab connection region, and each of the second tab connection region and/or the first tab connection region has a recessed inner surface.

In the second recessed region, the first tab and the second tab are electrically connected to each other, so that a current collected on the first conductive layer and a current collected on the second conductive layer can be collected together through the first tab and the second tab, so as to allow the current on the electrode plate to be collected and then flow to the post. In addition, a recessed surface is formed at the connection between the first tab connection region and the second tab connection region, and there is a certain pressing force therebetween. Thus, the connection effect is better.

In a possible implementation, each of the first recessed region and the second recessed region is a welding print. Since each of the first recessed region and the second recessed region is a welding print, the strength at the welding print is high, which can support the connection between the first current collector connection region and the first tab connection region and the connection between the second current collector connection region and the second tab connection region. Therefore, the tabs are not easily folded, and a dimensional accuracy of the welding is easier to be controlled.

In a possible implementation, the second tab further includes a second post connection region. The second post connection region has an end connected to an end of the second tab connection region facing away from the second current collector connection region and another end extending beyond the first tab connection region and connected to a post.

The first tab and the second tab are electrically connected to each other in the second recessed region, so that the current at the first tab and the current at the second tab are collected in the second recessed region. The second tab extends beyond the first tab connection region. The second tab is connected to the post, and the first tab does not need to be connected to the post, which can reduce the number of welding layers between the tabs and the post and the welding thickness of the tabs, and save the folding height of the tabs, thereby improving a volumetric energy density of the secondary battery.

In a second aspect of embodiments of the present disclosure, there is provided an electrode plate for a secondary battery including a current collector and a tab assembly. The current collector includes an insulation layer, a first conductive layer and a second conductive layer that are arranged on two surfaces of the insulation layer, respectively. The tab assembly includes a first tab and a second tab. The first tab includes a first current collector connection region and a first tab connection region that are connected to each other, and the second tab includes a second current collector connection region, a second tab connection region, and a second post connection region that are connected in sequence. The first current collector connection region is connected to the first conductive layer, and the second current collector connection region is connected to the second conductive layer. The first tab connection region is connected to the second tab connection region. The second post connection region has an end facing away from the second tab connection region. The end of the second post connection region extends beyond the first tab connection region and is connected to a post. A first through-hole passing through the current collector is disposed between the first current collector connection region and the second current collector connection region, and the first current collector connection region is electrically connected to the second current collector connection region at the first through-hole.

The first current collector connection region is connected to the first conductive layer, and thus a current on the first conductive layer can be collected onto the first tab. The second current collector connection region is connected to the second conductive layer, and thus a current on the second conductive layer can be collected onto the second tab. The first tab connection region is connected to the second tab connection region, the current on the first tab and the current on the second tab thus can be collected together and then connected to the post by the second post connection region. The second tab is connected to the post, and the first tab does not need to be connected to the post, which can reduce the number of welding layers between the tab and the post and the welding thickness of the tab, thereby saving the folding height of the tabs and improving a volumetric energy density of the secondary battery. A first through-hole is arranged on the current collector, and the first tab and the second tab are electrically connected to each other at the first through-hole. Thus, the first tab and the second tab can be connected at the through-hole so as to improve the connection strength between the first and second tabs and the current collector. Further, the first tab and the second tab are directly electrically connected to each other at the first through-hole, which increases an overcurrent capability between the first tab and the second tab.

In a possible implementation, each of the first current collector connection region and the second current collector connection region is recessed towards the first through-hole to weld the first current collector connection region and the second current collector connection region.

Each of a welding head and a welding seat has welding teeth arranged thereon. Thus, the first tab and the second tab at the first through-hole are both recessed inwardly to form a stable weld joint, which can realize an effective welding between the first tab and the second tab.

In a possible implementation, the first conductive layer, the insulation layer, and the second conductive layer of the current collector is penetration-welded to form the first through-hole. During welding the first tab and the second tab to the current collector, the current collector is directly penetration-welded completely, so that the first tab and the second tab are welded together at the first through-hole, thereby achieving high connection strength between the first tab and the second tab. Further, at the weld joint, the first tab and the second tab are connected to each other, which ensures a peel strength of the first tab and the second tab from the current collector and an integrity of the current collector.

In a possible implementation, the first current collector connection region has a first protrusion disposed on an inner surface thereof, and the second current collector connection region has a second protrusion disposed on an inner surface thereof. The first protrusion and the second protrusion are both arranged in the first through-hole and welded to each other in the first through-hole.

The first protrusion of the first tab and the second protrusion of the second tab are formed as an effective and stable weld joints at the first through-hole, and thus the connection effect is better.

In a possible implementation, the electrode plate of the secondary battery further includes a first conductive connection member disposed in the first through-hole. The first conductive connection member is connected to the first current collector connection region at one end thereof and to the second current collector connection region at the other end thereof.

The first tab and the second tab can be effectively connected at the first through-hole by the first conductive connection member, and the first tab and the second tab can be effectively connected to each other without excessive deformation.

In a possible implementation, the end of the first conductive connection member facing away from the second current collector connection region passes through the first through-hole and the first current collector connection region in sequence and is connected to the second current collector connection region.

The first conductive connection member passes through the first tab and is connected to the first tab, and the arrangement of the metal connection member can improve a connection force between the first tab and the second tab in a thickness direction, which can improve a tensile strength of the second tab.

In a possible implementation, the first conductive connection member passes through the first current collector connection region, the first through-hole and the second current collector connection region in sequence, and the first conductive connection member is connected to the first current collector connection region and the first current collector connection region at both ends thereof, respectively.

The first conductive connection member passes through both the first tab and the second tab, and the arrangement of the metal connection member can further improve the connection force between the first tab and the second tab in the thickness direction, which can improve the tensile strength of the first tab and the second tab.

In a possible implementation, a second through-hole passing through the first tab connection region and the second tab connection region is defined between the first tab connection region and the second tab connection region. In this possible implementation, the electrode plate of the secondary battery further includes a second conductive connection member disposed in the second through-hole and connected to the first tab connection region and the second tab connection region.

The first tab connection region and the second tab connection region are connected by a second metal connection member, so that an effective overcurrent can be generated between the first tab and the second tab. Further, the arrangement of the metal connection member can improve the connection force between the first tab and the second tab in the thickness direction, which can improve the tensile strength of the first tab and the second tab.

In a third aspect according to embodiments of the present disclosure, there is provided a secondary battery including a housing and an electrode assembly arranged in the housing. The electrode assembly includes a plurality of electrode plates, each of which is the electrode plate of the secondary battery as described above. Through the arrangement of the electrode plate of the secondary battery as described above, the connection between the tab and the current collector is firmer, and the overcurrent effect is better, and the volumetric energy density of the secondary battery can be increased.

In a fourth aspect according to embodiments of the present disclosure, there is provided a preparation method of the electrode plate of the secondary battery. The preparation method includes: arranging a first current collector connection region on a first conductive layer, and arranging a second current collector connection region on a second conductive layer; and placing a welding head on an outer surface of the first current collector connection region, placing a welding seat on an outer surface of the second current collector connection region, and penetration-welding an insulation layer by exerting a pressure between the welding head and the welding seat in such a manner that the first conductive layer abuts with the second conductive layer.

By the welding, the insulation layer at the weld joint is pressed towards a periphery of the weld join to be directly penetration-welded, so that an effective connection can be formed between the first conductive layer and the second conductive layer, and the connection between the first tab and the second tab in the first recessed region is firmer. In addition, the insulation layer is pressed at the weld joint, it is thus not necessary for the insulation layer to be perforated or for the current collector to be perforated first, so that an integrity of the current collector can be maintained to a certain extent while ensuring the connection strength, thereby ensuring a tensile strength of the tab assembly. Further, the first conductive layer and the second conductive layer are welded to each other, which can ensure a peel strength of a part of each of the first conductive layer and the second conductive layer from the insulation layer and a peel strength of the first tab and the second tab from the current collector.

In a possible implementation, the welding head is pressed against the welding seat by a pressure in a range from 2000N to 3500N, and an intensity of the pressure is in a range from 3 GPa to 4.5 GPa. This welding pressure and the intensity of the welding pressure is selected for penetration-welding the insulation layer without generating a relative friction between the first conductive layer and the second conductive layer. Thus, the welding strength is good, and the service life is long.

In a possible implementation, the welding seat and/or the welding head has a plurality of welding teeth arranged thereon.

In a case where a plurality of welding teeth is arranged on each of the welding seat and the welding head, the welding teeth on the welding seat and the welding teeth on the welding head are in one-to-one correspondence. In the first recessed region, the first current collector connection region and the second current collector connection region are both recessed towards the current collector in such a manner that the first conductive layer and the second conductive layer are welded to each other. In a case where there are no welding teeth arranged on the welding seat and the welding head has a plurality of welding teeth arranged thereon, each of the first current collector and the first conductive layer has a recessed outer surface in the first recessed region, and it is not necessary for the welding teeth to correspond to each other. Therefore, precision requirements of a welding machine are reduced, and there is no relative friction generated between the welding teeth, thereby enhancing the welding strength.

### BRIEF DESCRIPTION OF DRAWINGS

In order to illustrate the technical solutions of the embodiments of the present disclosure more clearly, the drawings that need to be used in the embodiments will be described briefly. It should be understood that the following drawings only show some embodiments of the present disclosure, and therefore should not be regarded as limiting the scope. For those of ordinary skill in the art, other related drawings may also be obtained from these drawings without inventive steps, which also falls within the scope of the present disclosure.

FIG. 1 is a first cross-sectional view of an electrode plate according to an embodiment of the present disclosure;

FIG. 2 is a cross-sectional view of a combination of a current collector and an active material layer according to an embodiment of the present disclosure;

FIG. 3 is a plan view of a combination of a current collector and an active material layer according to an embodiment of the present disclosure;

FIG. 4 is a plan view of an electrode plate according to an embodiment of the present disclosure;

FIG. 5 is a second cross-sectional view of an electrode plate according to an embodiment of the present disclosure;

FIG. 6 is a third cross-sectional view of an electrode plate according to an embodiment of the present disclosure;

FIG. 7 is a fourth cross-sectional view of an electrode plate according to an embodiment of the present disclosure;

FIG. 8 is a fifth cross-sectional view of an electrode plate according to an embodiment of the present disclosure;

FIG. 9 is a sixth cross-sectional view of an electrode plate according to an embodiment of the present disclosure;

FIG. 10 is a seventh cross-sectional view of an electrode plate according to an embodiment of the application; and

FIG. 11 is an eighth cross-sectional view of an electrode plate according to an embodiment of the present disclosure.

### REFERENCE SIGNS

1—electrode plate; 10—current collector; 20—tab assembly; 30—active material layer; 21—first tab; 22—second tab; 11—insulation layer; 12—first conductive layer; 13—second conductive layer; 121—first coating region; 122—first tab region; 131—second coating region; 132—second tab region; 211—first current collector connection region; 212—first tab connection region; 221—second collector connection region; 222—second tab connection region; 223—second post connection region; 40—first recessed region; 50—second recessed region; 60—welding print; 14—first through-hole; 2111—first protrusion; 2211—second protrusion; 15—first conductive connection member; 16—second through-hole; 17—second conductive connection member.

### DESCRIPTION OF EMBODIMENTS

In order to make the purposes, technical solutions and advantages of the embodiments of the present disclosure clearer, the technical solutions in the embodiments of the present disclosure will be described below with reference to the accompanying drawings in the embodiments of the present disclosure.

A secondary battery includes an electrode assembly and an outer housing. The outer housing includes a housing and a top cover plate. The electrode assembly is arranged in the housing. The top cover plate is mounted on the housing, and a post is fixed on the top cover plate. The electrode assembly includes a separator and a positive electrode plate and a negative electrode plate arranged on both sides of the separator. A current on the electrode plates is collected to the post by a tab.

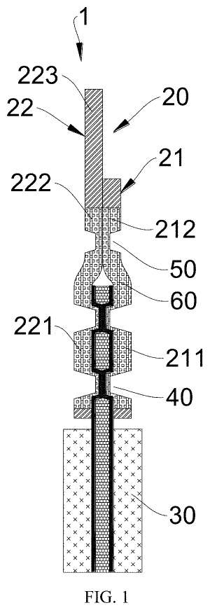

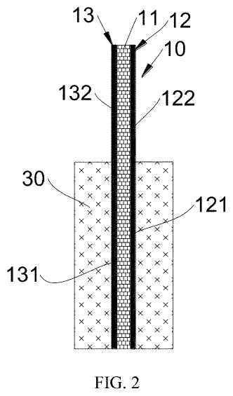

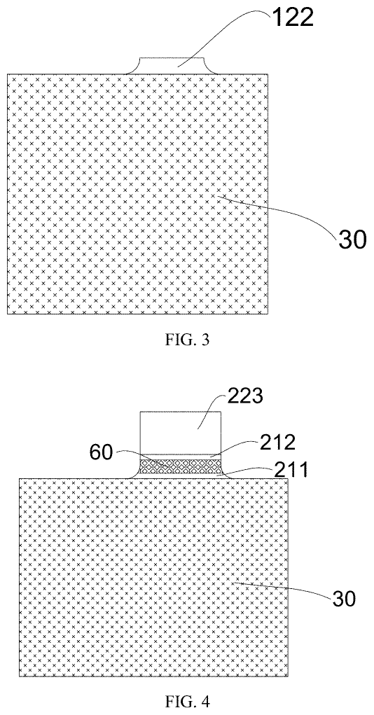

FIG. 1 is a first cross-sectional view of an electrode plate 1 according to the present embodiment, FIG. 2 is a cross-sectional view of a combination of a current collector 10 and an active material layer 30 according to the present embodiment, FIG. 3 is a current collector 10 and an active material layer 30 according to the present embodiment, and FIG. 4 is a plan view of the electrode plate 1 according to the present embodiment. Referring to FIGS. 1 to 4, in the embodiment of the present disclosure, an electrode plate 1 includes a current collector 10, a tab assembly 20 and an active material layer 30. The tab assembly 20 includes a first tab 21 and a second tab 22. The first tab 21 and the second tab 22 may be made of copper foil, aluminum foil or other conductive materials, and the material of the first tab 21 and the second tab 22 is not limited thereto in the present disclosure, as long as the material can have a good overcurrent effect. The current collector 10 includes an insulation layer 11, a first conductive layer 12 and a second conductive layer 13 respectively arranged on two surfaces of the insulation layer 11. The first conductive layer 12 has a first coating region 121 and a first tab region 122, and the second conductive layer 13 has a second coating region 131 and a second tab region 132. The active material layer 30 is coated onto the first coating region 121 and the second coating region 131.

The insulation layer 11 may be made of PET (Polyethylene terephthalate), PEN (Polyethylene naphthalate), PI (Polyimide), PP (Polypropylene), PE (polyethylene), non-woven fabrics, thin paper, and the like.

If the electrode plate 1 is a positive electrode plate, the first conductive layer 12 and the second conductive layer 13 may be an aluminum plating layer, and a positive pole active material layer 30 is coated onto the first coating region 121 of the first conductive layer 12 and the second coating region 131 of the second conductive layer 13. If the electrode plate 1 is a negative electrode plate, the first conductive layer 12 and the second conductive layer 13 may be a copper plating layer, and a negative pole active material layer 30 is coated onto the first coating region 121 of the first conductive layer 12 and the second coating region 131 of the second conductive layer 13. Of course, the first conductive layer 12 and the second conductive layer 13 are not limited to be made of the aluminum plating layer or the copper plating layer, and may be made of other suitable materials as desired, which are not limited in the embodiments of the present disclosure.

With continued reference to FIG. 1 and FIG. 4, the first tab 21 includes a first current collector connection region 211 and a first tab connection region 212 that are connected to each other, and the second tab 22 includes a second current collector connection region 221, a second tab connection region 222, and a second post connection region 223 that are connected in sequence. The first current collector connection region 211 covers and is connected to an outer surface of the first tab region 122 of the first conductive layer 12, and the second current collector connection region 221 covers and is connected to an outer surface of the second tab region 132 of the second conductive layer 13. The first tab connection region 212 extends beyond the first conductive layer 12, and the second tab connection region 222 extends beyond the second conductive layer 13. The first tab connection region 212 is connected to the second tab connection region 222, and an end of the second post connection region 223 facing away from the second tab connection region 222 extends beyond the first tab connection region 212 and is configured to be connected to a post.

That is, the first tab 21 is a short tab, and the second tab 22 is a long tab. Further, a current on the first conductive layer 12 can be transferred out by the short tab, and a current on the second conductive layer 13 can be transferred out by the long tab. Furthermore, the long tab and the short tab are interconnected between the first tab connection region 212 and the second tab connection region 222, so that the current is collected to the long tab and is connected to the long tab through the long tab, thereby realizing a collection of the current of the electrode plate 1 to the post. Since the long tab is connected to the post and the current on the short tab has been collected to the long tab, there is no need to connect the short tab and the post. Therefore, compared to the electrode plate with two tabs of same length, in the present disclosure, only the long tab needs to be connected, and thus the connection layers may be reduced by half in member, which can reduce a difficulty of the connection. Meanwhile, since the tab assembly 20 has a thickness reduced at a connection to the post, a height for folding the tab can be reduced, thereby improving a volumetric energy density of a battery. In addition, since the number of layers is halved, a weight of the tab assembly 20 can also be reduced, which can improve a gravimetric energy density of the battery.

In order to facilitate reading and identification, various regions included in the first tab 21 and the second tab 22 are distinguished when drawing the structural diagram. It should be noted that, in the preferred embodiment of the present disclosure, each of the first tab 21 and the second tab 22 may be integrally formed respectively for the convenience of production.

In order to weld the first tab connection region 212 of the first tab 21 and the second tab connection region 222 of the second tab 22 together, the first tab connection region 212 and the second tab connection region 222 are brought into contact with each other first, and then welded together. For example, the first tab 21 may be bent towards the second tab 22, so that the first tab connection region 212 is brought into contact with the second tab connection region 222. Alternatively, the second tab 22 may also be bent towards the first tab 21, so that the second tab connection region 222 is brought into contact with the first tab connection region 222. Further, alternatively, the first tab 21 may also be bent towards the second tab 22, and the second tab 22 is bent towards the first tab 21, so that the first tab connection region 212 and the second tab connection region 222 are brought into contact with each other.

Optionally, the second tab 22 has a length of 5 mm to 40 mm, in which the length refers to a length of the second tab 22 as shown in FIG. 1, i.e., a distance by which the second tab 22 extends from the second current collector connection region 221 to the second post connection region 223. With such a length of the second tab 22, it is possible to prevent an end of the first tab connection region 212 facing away from the first current collector connection region 211 (a unwelded length of the first tab connection region 212 is 1 mm to 5 mm) from affecting a welding between the second tab 22 and the post. In addition, it is also possible to avoid the second tab 22 from having too long length, which would result in redundancy.

It should be noted that, the first tab 21 may also be a long tab, and the second tab 22 may be a short tab, which is not limited in the present disclosure.

In order to realize the connection between the first tab 21 and the first conductive layer 12 and the connection between the second tab 22 and the second conductive layer 13, in the embodiment of the present disclosure, a recessed region 40 is defined at a connection between the tab assembly 20 and the current collector 10. In the first recessed region 40, the first collector connection region 211 of the first tab 21 and the first conductive layer 12 are stacked with each other and embedded in the insulation layers 11 together, and each of the first current collector connection region 211 and the first conductive layer 12 has a recessed outer surface. In addition, the first conductive layer 12 and the second conductive layer 13 are electrically connected to each other in the first recessed region 40.

A recess is formed on each of the first tab 21 and the first conductive layer 12 at the first recessed region 40, and the first conductive layer 12 and the second conductive layer 13 can be electrically connected to each other at the first recessed region 40. That is, at the first recessed region 40, the insulation layer 11 is pressed by the recessed first current collector connection region 211 and the recessed first conductive layer 12, so that the insulation layer 11 at the first recessed region diffuses towards a periphery thereof to be penetrated, which results in an electrical connection between the first conductive layer 12 and the second conductive layer 13 at the first recessed region 40. Therefore, the connection between the first current collector connection region 211 and the first conductive layer 12 as well as the connection between the second conductive layer 13 and the second current collector connection region 221 at the first recessed region 40 are firmer, and a certain overcurrent effect can be achieved.

Optionally, the first current collector connection region 211, the first conductive layer 12, the second conductive layer 13 and the second current collector connection region 221 are welded at the first recessed region 40. The connection at the first recessed region 40 is formed as a weld joint by welding, which can provide a firmer connection. Further, the insulation layer 11 is pressed at the weld joint, and thus it is possible to ensure an integrity of the current collector 10 to a certain extent while ensuring a connection strength, thereby ensuring a tensile strength of the tab assembly 20. In addition, since the first conductive layer 12 and the second conductive layer 13 are welded to each other, a peel strength of the first conductive layer 12 and the second conductive layer 13 from the insulation layer 11 can be improved. Meanwhile, the weld joint formed by the first current collector connection region 211 and the second current collector connection region 221 in the first recessed region 40 can ensure a peel strength of the first tab 21 and the second tab 22 from the current collector 10.

In this embodiment of the present disclosure, a plurality of first recessed regions 40 may be formed on the first current collector connection region 211 and the second current collector connection region 221, and the plurality of first recessed regions 40 may be a plurality of weld joints that is arranged in an array or in other arrangements. The arrangement is related to an arrangement of welding teeth of a welding head or/and a welding seat.

In order to weld the first tab 21, the first conductive layer 12, the second tab 22 and the second conductive layer 13 at the first recessed region 40 together, the welding head is placed on an outer surface of the first current collector connection region 211, and the welding seat is placed on an outer surface of the second current collector connection region 221. In this way, when a pressure is exerted between the welding head and the welding seat to penetration-weld the insulation layer 11 in such a manner that the first conductive layer 12 abuts with the second conductive layer 13.

By welding, the insulation layer 11 at the weld joint is pressed towards a periphery of the weld joint to be directly penetration-welded, so that an effective connection between the first conductive layer 12 and the second conductive layer 13 can be formed, and the connection between the first tab 21 and the second tab 22 in the first recessed region 40 is firmer. In addition, the insulation layer 11 is pressed at the weld joint, it is thus not necessary for the insulation layer 11 to be perforated or for the current collector 10 to be perforated first, so that an integrity of the current collector 10 can be maintained to a certain extent while ensuring the connection strength, thereby ensuring the tensile strength of the tab assembly 20. Further, the first conductive layer 12 is welded to the second conductive layer 13, which can ensure the peel strength of the first conductive layer 12 and the second conductive layer 13 from the insulation layer 11. Meanwhile, the weld joint formed by the first current collector connection region 211 and the second current collector connection region 221 in the first recessed region 40 can ensure the peel strength of the first tab 21 and the second tab 22 from the current collector 10.

The first tab 21, the first conductive layer 12, the second conductive layer 13 and the second tab 22 at the first recessed region 40 are welded together by weld joints. Therefore, the first tab 21 can be effectively connected to the first conductive layer 12, and the second tab 22 can be effectively connected to the second conductive layer 13. Further, the current of the first conductive layer 12 can be transferred to the first tab 21, and the current of the second conductive layer 13 can be transferred to the second tab 22. In addition, a certain overcurrent effect can also be formed at the weld joint. At the weld joint, a part of the current of the first conductive layer 12 may be transferred to the second conductive layer 13 and then be collected to the second tab 22.

Further, the first tab 21, the first conductive layer 12, the second conductive layer 13 and the second tab 22 at the plurality of first recessed regions 40 are welded together by a plurality of weld joints. Thus, a parallel connection of a plurality of current paths between the first conductive layer 12 and the second conductive layer 13 of the current collector 10 can be implemented, and the overcurrent capability can be satisfied through a plurality of small weld joints. Further, compared with one large weld joint, through the connection by the plurality of small weld joints, it is possible to maintain the integrity of the insulation layer 11 of the current collector 10 to a relatively greater extent, and increase the path for transferring the current from the conductive layer of the current collector 10 to the tabs.

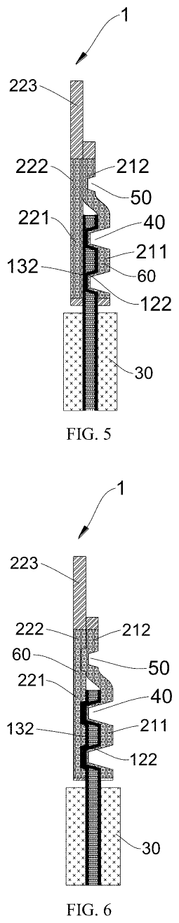

In order to penetration-weld the insulation layer 11 by welding, the insulation layer 11 is pressed towards the periphery of the weld joint. In the embodiment of the present disclosure, a pressure of pressing the welding head against the welding seat is in a range from 2000N to 3500N, and an intensity of the pressure is in a range from 3 GPa to 4.5 GPa. The welding method may be an ultrasonic welding or a resistance welding, which is not limited in the embodiment of the present disclosure, as long as the penetration-welding of the insulation layer 11 may be implemented, which are all within the scope of the embodiments of the present disclosure. Optionally, the welding pressure may be 2000N, 2500N, 3000N or 3500N, and the intensity of the welding pressure may be 3 GPa, 3.5 GPa, 4 GPa or 4.5 GPa. FIG. 5 is a second cross-sectional view of the electrode plate 1 according to the present embodiment. Referring to FIG. 5, in an embodiment, in the first recessed region 40, the second current collector connection region 221 has a flat surface facing away from the second conductive layer 13, and the second conductive layer 13 is flat. The first recessed region 40 is recessed at one surface thereof and is not recessed at the other surface thereof. The welding seat has no welding teeth disposed thereon, and the welding head has a plurality of welding teeth disposed thereon. One welding tooth may be formed as one recess. That is, at the first recessed region 40, neither the second tab 22 nor the second conductive layer 13 is recessed, and each of the first tab 21 and the first conductive layer 12 is recessed towards second tab 22. In this way, the insulation layer 11 is penetration-welded, and the insulation layer 11 is pressed towards the periphery thereof, such that the first conductive layer 12 and the second conductive layer 13 are welded to each other. The welding teeth need to be arranged on the welding head of the welding machine, and welding teeth do not need to be arranged on the welding seat.

During the welding, a friction is generated between the welding teeth on the welding head and the welding teeth on the welding seat (since there are no welding teeth on the welding seat), which can reduce a metal powder and greatly reduce an amount of metal powder falling on the electrode plate 1 to avoid a performance of the battery from being affected. In addition, in order to arrange the welding teeth, there is no need for a one-to-one correspondence between the welding teeth on the welding seat and the welding teeth on the welding head, which can reduce a processing accuracy of the welding machine and accuracy requirements of the corresponding positional relationship between the welding seat and the welding head, thereby reducing welding difficulty.

In another embodiment, FIG. 6 is a third cross-sectional view of the electrode plate 1 according to the present embodiment. Referring to FIG. 6, in the first recessed region 40, the second current collector connection region 221 has a flat surface facing away from the second conductive layer 13. The second conductive layer 13 is embedded within the second current collector connection region 221 and the second conductive layer 13 has a recessed inner surface recessed towards the outer surface of the second current collector connection region 221. The second tab 22 is not recessed on a surface thereof facing away from the second conductive layer 13. Each of the first tab 21 and the first conductive layer 12 is recessed towards the second tab 22, and the second conductive layer 13 is recessed towards the second tab 22. Further, the second conductive layer 13 at the first recessed region 40 is embedded into the second tab 22, and the first tab 21, the first conductive layer 12 and the second conductive layer 13 are simultaneously pressed towards the second tab 22, so that the insulation layer 11 is penetration-welded and the second conductive layer 13 is embodied into the second tab 22 without penetration-welding the second tab 22, thereby achieving a firm connection at the first recessed region 40.

In other embodiments, at the first recessed region 40, the first tab 21 and the first conductive layer 12 may not be recessed, and the second tab 22 and the second conductive layer 13 may be recessed. Optionally, each of the first conductive layer 12 and the first tab 21 is flat. Alternatively, the first tab 21 has a flat surface facing away from the first conductive layer 12 is flat, and the first conductive layer 12 is embedded into the first tab 21.

In one implementation, in the first recessed region 40, the second current collector connection region 221 and the second conductive layer 13 are embedded within the insulation layer 11, and the outer surface of each of the second current collector connection region 221 and the second conductive layer 13 is recessed. That is, at the first recessed region 40, both surfaces are recessed towards the insulation layer 11, and the insulation layer 11 is pressed by both the first conductive layer 12 and the second conductive layer 13 to the periphery thereof to implement the welding of the first conductive layer 12 to the second conductive layer 13.

The welding teeth has a height in a range from 60 um to 200 um, and a tooth crest of each welding tooth has a length and a width in a range from 0.2 mm to 0.5 mm. Each welding tooth has relatively high height, and thus the above various weld joints may be formed to form the plurality of first recessed regions 40 as described above. For example: each welding tooth may have a height of 60 um, 100 um, 150 um or 200 um, and the tooth crest of each welding tooth may have a length and a width of 0.2 mm, 0.3 mm, 0.4 mm or 0.5 mm.

In order to realize the connection between the first tab connection region 212 and the second tab connection region 222, the welding is optional. A second recessed region 50 is defined at the connection between the first tab connection region 212 and the second tab connection region 222. In the second recessed region 50, the first tab connection region 212 is electrically connected to the second tab connection region 222, and the outer surface of the second tab connection region 222 and/or of the first tab connection region 212 is recessed.

Please refer to FIG. 1, FIGS. 4 to 6 together, if each of the first recessed region 40 and the second recessed region 50 is a welding print 60, that is, the connections between the first tab 21 and the first conductive layer 12, between the second tab 22 and the second conductive layer 13, and between the first tab 21 and the second tab 22 are completed at one time, the connection of the entire electrode plate 1 can be completed by welding at one time, and thus the welding print 60 of the resulted electrode plate 1 is relatively hard, which can support a bottom of the tab (the connection between the collector connection region and the tab connection region of the tab). Therefore, during a strip continuous transportation, the tabs are not easy to be folded, and a dimensional accuracy of the welding is easy to be controlled. During the welding, some of the welding teeth on the welding head correspond to the tab connection regions, and some of the welding teeth correspond to the current collector connection regions. When welding by the welding seat and the welding head, welding teeth on an upper end of the welding head correspond to the first recessed region 40, welding teeth on an lower end of the welding head correspond to the second recessed region 50, so that one welding print 60 can be implemented to complete the welding of the electrode plate 1.

In order to form one welding print 60 on the electrode plate 1, the second recessed region 50 should be recessed in a same direction as the first recessed region 40. That is, if in the first recessed region 40 the second tab 22 has a flat surface facing away from the second conductive layer 13 and the first tab 21 and the first conductive layer 12 are recessed towards the second tab 22 to penetration-weld the insulation layer 11 in such a manner that and the first conductive layer 12 and the second conductive layer 13 are welded to each other, at the second recessed region 50, the second tab 22 has a flat surface facing away from the first tab 21, and the first tab 21 is recessed towards the second tab 22 and embedded within the second tab 22 without penetration-welding the second tab 22. Alternatively, if at the first recessed region 40 the second tab 22 and the second conductive layer 13 are recessed towards the insulation layer 11 and the first tab 21 and the first conductive layer 12 are recessed towards the insulation layer 11 to penetration-weld the insulation layer 11 in such a manner that the first conductive layer 12 and the second conductive layer 13 are welded to each other, at the second recessed region 50, the first tab 21 is recessed towards the second tab 22, and the second tab 22 is recessed towards the first tab 21, so that the weld joint has an I-shaped cross section.

Further, the welding print 60 has a length in a range from 2 mm to 6 mm, and a welding position where the welding teeth are disposed on each of the welding head and the welding seat accordingly has a length in a range from 2 mm to 6 mm, wherein the length herein refers to a distance by which the welding print 60 extends from the second current collector connection region 221 to the second tab connection region 222. In this way, it is possible to meet amplitude requirements of the welding head and ensure a rigidity of the welding head, thereby improving a welding strength while ensuring the volumetric energy density.

It should be noted that, even if the first recessed region 40 is recessed in the same direction as the second recessed region 50, the welding may be performed by using two welding prints 60. If the first recessed region 40 is recessed in a different direction from the second recessed region 50, the two welding prints 60 are required for welding. If the first recessed region 40 is recessed in the different direction from the second recessed region 50, the welding teeth may also be arranged on the welding seat and the welding head respectively, and the welding teeth on the welding seat do not correspond to the welding teeth on the welding head. The welding of the electrode plate 1 is implemented through one welding print 60, and the embodiments of the present disclosure are not limited thereto.

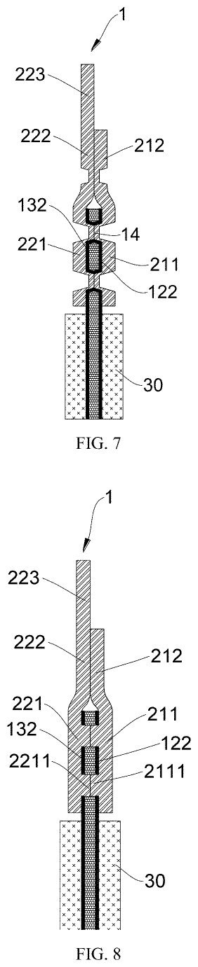

FIG. 7 is a fourth cross-sectional view of the electrode plate 1 according to the present embodiment, and FIG. 8 is a fifth cross-sectional view of the electrode plate 1 according to the present embodiment. Please refer to FIG. 2, FIG. 7 and FIG. 8, a first through-hole 14 passing through the current collector 10 (in a thickness direction of the current collector 10) is defined between the first current collector connection region 211 and the second current collector connection region 221, and the first current collector connection region 211 and the second current collector connection region 221 are electrically connected to each other at the first through-hole 14. By connecting the first tab 21 and the second tab 22 at the first through-hole 14. the connection strength between the first and second tabs 21, 22 and the current collector 10 can be improved, and the first tab 21 and the second tab 22 connected at the first through-hole 14 can also have a predetermined overcurrent capability, which can provide better current collection effect.

In one implementation, with continued reference to FIG. 7, the first current collector connection region 211 and the second current collector connection region 221 are both recessed towards the first through-hole 14, so that the first current collector connection region 211 and the second current collector connection region 221 are welded to each other. The first tab 21 and the second tab 22 are both recessed towards the first through-hole 14 by the welding, and the welding teeth are arranged on each of the welding seat and the welding head. During welding, the welding teeth on the welding head corresponds to the welding teeth on the welding seat to be pressed into the first through-hole 14. In this way, a material in a pressed region is recessed towards an inside of the first through-hole 14, so that a stable weld joint can be formed between the first tab 21 and the second tab 22 in contact with each other in the first through-hole 14.

Optionally, the outer surface of each of the first tab connection region 212 and the second tab connection region 222 is recessed, and the welding is performed at the recessed positions. Optionally, the welding teeth are arranged on each of the welding seat and the welding head. During welding, the welding seat is arranged on the outer surface of the first tab connection region 212, and the welding head is arranged on the outer surface of the second tab connection region 222. A pressure welding is performed between the welding head and the welding seat, so that the first tab connection region 212 is recessed towards the second tab connection region 222, and the second tab connection region 222 is recessed towards the first tab connection region 212 to achieve a stable welding between the first tab connection region 212 and the second tab connection region 222. Of course, the first tab connection region 212 may also be recessed towards the second tab connection region 222, and the second tab connection region 222 has a flat outer surface, or the first tab connection region 212 has a flat outer surface, and the second tab connection region 222 is recessed towards the first tab connection region 212. The embodiments of the present disclosure are not limited in this regard.

Optionally, the first through-hole 14 may be formed by penetration-welding the first conductive layer 12, the insulation layer 11 and the second conductive layer 13 of the current collector 10, rather than being formed on the current collector 10 first. During welding the first tab 21 and the second tab 22 to the current collector 10, the current collector 10 is directly penetration-welded completely, so that the first tab 21 and the second tab 22 are welded together at the first through-hole 14, thereby achieving high connection strength between the first tab 21 and the second tab 22. Further, at the weld joint, the first tab 21 and the second tab 22 are connected to each other, which ensures the peel strength of the first tab 21 and the second tab 22 from the current collector 10 and the integrity of the current collector 10.

In another embodiment, with continued reference to FIG. 8, the first current collector connection region 211 has a first protrusion 2111 disposed on an inner surface thereof, and the second current collector connection region 221 has a second protrusion 2211 disposed on an inner surface thereof. The first protrusion 2111 and the second protrusion 2211 are both located within the first through-holes 14 and welded with each other in the first through-hole 14. There are no welding teeth on the welding head and welding seat of the welding machine. By means of resistance welding, ultrasonic welding or other welding methods, each of the first tab 21 and the second tab 22 is not recessed at the first through-hole 14 (each of the first tab 21 and the second tab 22 has a flat outer surface). Instead, the first tab 21 is formed with the first protrusion 2111, and the second tab 22 is formed with the second protrusion 2211 (the inner surfaces of the first tab 21 and the second tab 22 are both formed with the protrusions), and thus a stable and effective welding between the first protrusions 2111 and the second protrusions 2211 is formed in the first through-hole 14.

Optionally, the welding of the first tab connection region 212 and the second tab connection region 222 may also be performed by means of resistance welding without forming the recess. It should be noted that a welding portion at the first through-hole 14 may be recessed, and the first tab connection region 212 and the second tab connection region 222 may not be recessed. Alternatively, no recess may not be formed at the first through-hole 14, and the welding is performed by forming recesses in the first tab connection region 212 and the second tab connection region 222 through forming the protrusions at both ends, which are all within the scope of the present disclosure.

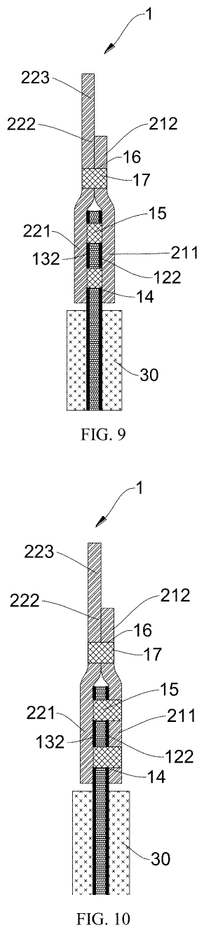

In one embodiment, FIG. 9 is a sixth cross-sectional view of the electrode plate 1 according to the present embodiment. Referring to FIG. 9, a first conductive connection member 15 may also be disposed in the first through-hole 14. The first conductive connection member 15 is connected to the first current collector connection region 211a at one end thereof and to the second current collector connection region 221 at the other end thereof.

By arranging the first conductive connection member 15 in the first through-hole 14, and then connecting the first tab 21 and the second tab 22 to both ends of the first conductive connection member 15 by the welding, the stable connection between the first tab 21 and the second tab 22 can be achieved, thereby better overcurrent effect is provided between the first tab 21 and the second tab 22.

Optionally, FIG. 10 is a seventh cross-sectional view of the electrode plate 1 according to the present embodiment. Referring to FIG. 10, the first conductive connecting member 15 has an end facing away from the second current collector connection region 221. The end of the first conductive connecting member 15 passes through the first through-hole 14 and the first current collector connection region 211 in sequence and is connected to the first current collector connection region 211. The first conductive connection member 15 and the second current collector connection region 221 are integrally formed. The first conductive connection member 15 passes through the first through-hole 14 to be connected to the first current collector connection region 211, and then passes through the first current collector connection region 211 to be welded to the first tab 21, thereby forming the stable connection.

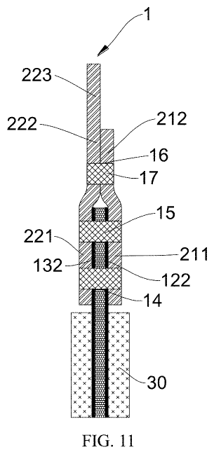

Optionally, FIG. 11 is an eighth cross-sectional view of the electrode plate 1 according to the present embodiment. Referring to FIG. 11, the first conductive connection member 15 passes through the first current collector connection region 211, the first through-hole 14 and the second current collector connection region 221 in sequence, and the first conductive connection member 15 is connected to the first current collector connection region 211 and the second current collector connection region 221 at both ends thereof, respectively. The first conductive connection member 15 passes through both the first current collector connection region 211 and the second current collector connection region 221, and is welded to the first tab 21 and the second tab 22, thereby forming the stable connection.

Further, the electrode plate 1 further includes a second conductive connection member 17. A second through-hole 16 passing through the first tab connection region 212 and the second tab connection region 222 is arranged between the first tab connection region 212 and the second tab connection region 222. The second conductive connecting member 17 is arranged in the second through-hole 16 and connected to the first tab connection region 212 and the second tab connection region 222.

In the embodiment of the present disclosure, a plurality of first through-holes 14 and a plurality of second through-holes 16 may be provided. The plurality of first through-holes 14 is arranged in the first current collector connection region 211 and the second current collector connection region 221 in an array, and the plurality of second through-holes 16 are arranged in the first tab connection region 212 and the second tab connection region 222 in an array, so as to improve the connection strength of the tabs and the overcurrent capability between the first tab 21 and the second tab 22.

According to the above description, the electrode plate 1 according to the present disclosure has the following beneficial effects.

(1) When connecting the tabs to the posts, only the long tab needs to be welded to the posts, which may halve the number of connection layers of the tabs and reduce the thickness of the tabs, thereby improving the volumetric energy density and the gravimetric energy density of the battery.

(2) At the first recessed region 40, the first current collector connection region 211 is welded to the first tab region 122 of the first conductive layer 12, and the second current collector connection region 221 is welded to the second tab region 132 of the second conductive layer 13, and the insulation layer 11 at the first recessed region 40 is penetration-welded, so that the insulation layer 11 is pressed towards the periphery thereof. Thus, the connection strength at the first recessed region 40 is higher, the first conductive layer 12 and the second conductive layer 13 have a predetermined overcurrent capability at the first recessed region 40, thereby providing better a current collection effect, and maintaining the integrity of the current collector 10 to a certain extent.

(3) At the first recessed region 40, the second current collector connection region 221 has a flat surface facing away from the second conductive layer 13, the second conductive layer 13 is flat and embedded within the second current collector connection region 221 and the second conductive layer 13 is embedded within the second current collector connection region 221. In order to achieve the above structure, during the welding, the welding seat has no welding teeth arranged thereon, and the welding head has the welding teeth arranged thereon, which can prevent the friction from being generated between the welding teeth on the welding seat and the welding teeth on the welding head during the welding, i.e., prevent the friction from being generated between the first conductive layer 12 and the second conductive layer 13, thereby avoiding the first conductive layer 12, the second conductive layer 13, the first current collector connection region 211, the second current collector connection region 221, the first tab connection region 212 and the second tab connection region 222 from being penetration-welded. In addition, it is possible to avoid more metal powder from being generated, and reduce the risk of the metal powder falling on the electrode plate 1. Therefore, the tabs have better connection effect, and it is possible to prevent the performance of the battery from being adversely affected by the falling of the metal powder.

(4) The plurality of first recessed regions 40 form a plurality of weld joints, which can achieve the connection reliability of the tabs and the parallel connection of the plurality of current paths between the first conductive layer 12 and the second conductive layer 13 of the current collector 10. Further, the overcurrent capability can be satisfied by a plurality of small weld joints. In addition, compared with one large weld joint, through the connection by the plurality of small weld joints, it is possible to maintain the integrity of the insulation layer 11 of the current collector 10 to a relatively greater extent, and increase the paths for transferring the current from the conductive layer of the current collector 10 to the tabs. Meanwhile, the tensile strength of the tab assembly 20 can be improved.

(5) each of the welding of the first current collector connection region 211, the first conductive layer 12, the second conductive layer 13 and the second current collector connection region 221 and the welding of the first tab connection region 212 and the second tab connection region 222 are one welding print 60, and the connection between the tab and the current collector 10 and the connection between the tab and the tab are completed at one time, the bottom of the tab (the connection between the collector connection region of the tab and the tab connection region) can be supported. During the continuous transportation, the tabs are not easy to be folded, and the dimensional accuracy of welding is easy to be controlled.

(6) By arranging the conductive connection member in the first through-hole 14 of the current collector 10, the connection strength in a thickness direction of the tab is stronger, which can improve the tensile strength of the first tab 21 and the second tab 22.

The above descriptions are only a part of the embodiments of the present disclosure, and are not intended to limit the present disclosure. For those skilled in the art, various modifications and changes may be made to the present disclosure. Any modification, equivalent replacement, improvement, etc. made within the spirit and principle of the present disclosure shall be fallen within the scope of the present disclosure.

### INDUSTRIAL APPLICABILITY

Due to the specific arrangement of the long and short tabs of the electrode plate and the electrical connection between the first conductive layer and the second conductive layer in the first recessed region, compared with the existing electrode plate, in the electrode plate according to the embodiments of the present disclosure, each of the tabs has reduced thickness, and the volumetric energy density and the gravimetric energy density are improved, while the effective connection between the first tab and the second conductive layer, and between the second tab and the second conductive layer are ensured. In addition, the welding is carried out at the first recessed region to penetration-weld the insulation layer. In this way, it is possible to allow the first conductive layer and the second conductive layer to have a predetermined overcurrent capability at the first recessed region, thereby providing better current collection effect and maintaining the integrity of the current collector to a certain extent. At the first recessed region, the second current collector connection region has a flat surface facing away from the second conductive layer, and the second conductive layer is flat. In this manner, it is possible to avoid more metal powder from being generated during the welding, thereby providing better connection effect of the tabs. Further, since the plurality of weld joints is formed in the plurality of first recessed regions, the integrity of the insulation layer of the current collector can be maintained to a relatively greater extent, and the paths for transferring the current from conductive layer of the current collector to the tabs can be increased, while the tensile strength of the tab assembly is improved. In addition, the arrangement of the welding print can prevent the tabs from being easily folded during the continuous transportation when welding, and the dimensional accuracy of the welding is easy to be controlled. However, by arranging the conductive connection member in the first through-hole of the current collector, the connection strength in the thickness direction of the tab is increased, thereby improving the tensile strength of the first tab and the second tab.

Due to the above advantages of the electrode plate according to the embodiments of the present disclosure, the secondary battery including the electrode plate has better performance.

1. An electrode plate of a secondary battery, comprising:
a current collector comprising an insulation layer, a first conductive layer and a second conductive layer that are arranged on two surfaces of the insulation layer, respectively; and
a tab assembly comprising a first tab and a second tab, the first tab comprising a first current collector connection region that covers and is connected to an outer surface of the first conductive layer, and the second tab comprising a second current collector connection region that covers and is connected to an outer surface of the second conductive layer,
wherein a first recessed region is defined at a connection between the tab assembly and the current collector, wherein in the first recessed region, the first current collector connection region of the first tab and the first conductive layer are stacked with each other and both embedded in the insulation layer, and each of the first current collector connection region and the first conductive layer has a recessed outer surface, and wherein the first conductive layer is electrically connected to the second conductive layer in the first recessed region.

2. The electrode plate of the secondary battery according to claim 1, wherein the first current collector connection region, the first conductive layer, the second conductive layer, and the second current collector connection region are welded in the first recessed region.

3. The electrode plate of the secondary battery according to claim 2, wherein in the first recessed region, the second current collector connection region and the second conductive layer are stacked with each other and both embedded in the insulation layer, and each of the second current collector connection region and the second conductive layer has a recessed outer surface.

4. The electrode plate of the secondary battery according to claim 2, wherein in the first recessed region, the second current collector connection region has a flat surface facing away from the second conductive layer.

5. The electrode plate of the secondary battery according to claim 4,
wherein the second conductive layer is flat in the first recessed region; or
wherein in the first recessed region, the second conductive layer is embedded within the second current collector connection region, and the second conductive layer has a recessed inner surface recessed towards the outer surface of the second current collector connection region.

6. The electrode plate of the secondary battery according to claim 1,
wherein the first tab further comprises a first tab connection region connected to the first current collector connection region, and the second tab further comprises a second tab connection region connected to the second current collector connection region; and
wherein a second recessed region is defined at a connection between the first tab connection region and the second tab connection region, and wherein in the second recessed region, the first tab connection region is electrically connected to the second tab connection region, and the second tab connection region and/or the first tab connection region has a recessed outer surface.

7. The electrode plate of the secondary battery according to claim 6, wherein each of the first recessed region and the second recessed region is a welding print.

8. The electrode plate of the secondary battery according to claim 6, wherein the second tab further comprises a second post connection region, the second post connection region having one end connected to an end of the second tab connection region facing away from the second current collector connection region and another end extending beyond the first tab connection region and connected to a post.

9. An electrode plate of a secondary battery, comprising:
a current collector comprising an insulation layer, a first conductive layer and a second conductive layer that are arranged on two surfaces of the insulation layer, respectively; and
a tab assembly comprising a first tab and a second tab, the first tab comprising a first current collector connection region and a first tab connection region that are connected to each other, and the second tab comprising a second current collector connection region, a second tab connection region, and a second post connection region that are connected in sequence, wherein the first current collector connection region is connected to the first conductive layer, and the second current collector connection region is connected to the second conductive layer, and wherein the first tab connection region is connected to the second tab connection region;
wherein an end of the second post connection region facing away from the second tab connection region extends beyond the first tab connection region and is connected to a post, and wherein a first through-hole passing through the current collector is defined between the first current collector connection region and the second current collector connection region, and the first current collector connection region is electrically connected to the second current collector connection region at the first through-hole.

10. The electrode plate of the secondary battery according to claim 9, wherein each of the first current collector connection region and the second current collector connection region is recessed towards the first through-hole to weld the first current collector connection region to the second current collector connection region.

11. The electrode plate of the secondary battery according to claim 10, wherein the first conductive layer, the insulation layer, and the second conductive layer of the current collector are penetrated to form the first through-hole.

12. The electrode plate of the secondary battery according to claim 9, wherein the first current collector connection region has a first protrusion disposed on an inner surface thereof, and the second current collector connection region has a second protrusion disposed on an inner surface thereof, the first protrusion and the second protrusion being both arranged in the first through-hole and welded with each other in the first through-hole.

13. The electrode plate of the secondary battery according to claim 9, further comprising a first conductive connection member disposed in the first through-hole, wherein the first conductive connection member is connected to the first current collector connection region at one end thereof and to the second current collector connection region at the other end thereof.

14. The electrode plate of the secondary battery according to claim 13, wherein the end of the first conductive connection member facing away from the second current collector connection region passes through the first through-hole and the first current collector connection region in sequence and is connected to the second current collector connection region.

15. The electrode plate of the secondary battery according to claim 14, wherein the first conductive connection member passes through the first current collector connection region, the first through-hole and the second current collector connection region in sequence, and wherein two ends of the first conductive connection member are connected to the first current collector connection region and the second current collector connection region, respectively.

16. The electrode plate of the secondary battery according to claim 13, further comprising
a second through-hole passing through the first tab connection region and the second tab connection region,
wherein the electrode plate of the secondary battery further comprises a second conductive connection member disposed in the second through-hole and connected to the first tab connection region and the second tab connection region.

17. A secondary battery, comprising:
a housing; and
an electrode assembly arranged in the housing, the electrode assembly comprising a plurality of electrode plates, each of the plurality of electrode plates being the electrode plate of the secondary battery according to claim 1.

18. A preparation method of the electrode plate of the secondary battery according to claim 2, the preparation method comprising:
arranging the first current collector connection region on the first conductive layer, and arranging the second current collector connection region on the second conductive layer; and
placing a welding head on the outer surface of the first current collector connection region, placing a welding seat on the outer surface of the second current collector connection region, and exerting a pressure onto the welding head towards the outer surface of the first current collector connection region such that the insulation layer is penetrated and the first conductive layer abuts with the second conductive layer.

19. The preparation method according to claim 18, wherein the pressure exerted onto the welding head is in a range from 2000N to 3500N, and wherein an intensity of the pressure is in a range from 3 GPa to 4.5 GPa.

20. The preparation method according to claim 18, wherein the welding seat and/or the welding head has a plurality of welding teeth arranged thereon.
